(19) United States
(12) Patent Application Publication
(10) Pub. No.: US 2010/0078560 A1
(43) Pub. Date: Apr. 1, 2010

(54) GAS DETECTOR

(76) Inventor: Paul John Basham, High Wycombe (GB)

Correspondence Address: LAW OFFICE OF JAMES TROSINO, P.O. BOX 200, YONKERS, NY, 10703, US

(21) Appl. No.: 12/440,261

(22) PCT Filed: Sep. 10, 2007
(86) PCT No.: PCT/GB2007/003407

§ 371 Date: Mar. 15, 2009

(30) Foreign Application Priority Data
Sep. 8, 2006 (GB) 0617719.0

(51) Int. Cl. G01N 21/59; G01J 5/02; G01N 21/00

(52) U.S. Cl. 250/338.5; 250/340; 356/437

(57) ABSTRACT

A gas detector 10 comprising a first radiation source 12 for emitting radiation at a first frequency, a second radiation source 14 for emitting radiation at a second frequency, a radiation detector 18 adapted simultaneously to detect temporally overlapping radiation from both the first and second radiation sources which in use pass through a sample region 16 located between the first and second radiation sources 12, 14 and the detector 18, and further, comprising a processor 20 enabling comparison of the radiation detected by the detector 18 from the first and second radiation sources 12, 14 thereby to determine the level of a pre-determined gas in the sample region.

This invention relates to a gas detector and a method of gas detection in particular to a means of extracting two streams of data to be used in a gas measurement algorithm from optically combined signals.

It is known to provide a gas detector to determine a target gas level which may be derived from an optical system including one or more optical detectors.

When measuring flammable gas by optical means it is known to measure both in one or more wavebands of light absorbed by the target gas and in one or more wavebands not absorbed by the target gas. The selection of the second wavebands is commonly known as the reference signal and by taking the ratio with the first set of wavebands, commonly known as the absorption signal, this allows calculation of the level of target gas and also compensation of many parameters including ageing of components and degradation of the optical system. It is normally necessary to either use more than one optical detector in the system or to accept non-simultaneous measurement of gas and reference signals.

However, it is known from EP 0 502 717, to use only a single detector. The technique determining the ratio of the reference and absorption signals is however rather complex requiring the use of a multiplexer/demultiplexer circuit in order to effect the determination of the ratio of the signals from the phase separated carrier signals.

It is an object of the invention to improve on the above designs, in particular to allow simple extraction of both reference and absorption signals as defined above, or at least a ratio of both, from information derived from a single optical detector. It is an object of the invention to derive this information rapidly and simultaneously for both signals without the need for the system to stabilise between capturing the signal data.

According to the first aspect of the invention there is provided a gas detector comprising a first radiation source for emitting radiation at a first frequency, a second radiation source for emitting radiation at a second frequency, a radiation detector adapted simultaneously to detect radiation from both the first and second radiation sources which in use passes through a sample region located between the first and second radiation sources and the detector, further, comprising a processor enabling comparison of the radiation detected by the detector from the first and second radiation sources thereby to determine the level of a target gas in the sample region. Beneficially, the first and second radiation sources are operated simultaneously such that radiation from the sources temporally overlap and are simultaneously detected by the detector whilst the processor is adapted to analyse this signal to enable determination of the presence of any target gas. Hence, a detector output is provided wherein both absorption and reference signals have been combined by an optical system. Each signal is the result of a sinusoidally driven light source targeted at absorption wavebands and non-absorbing wavebands for the target gas. The path of the light thus generated passes through the atmosphere being measured and is detected by an optical detector.

Other aspects of the invention and preferred features of the invention are set out in the claims appended hereto.

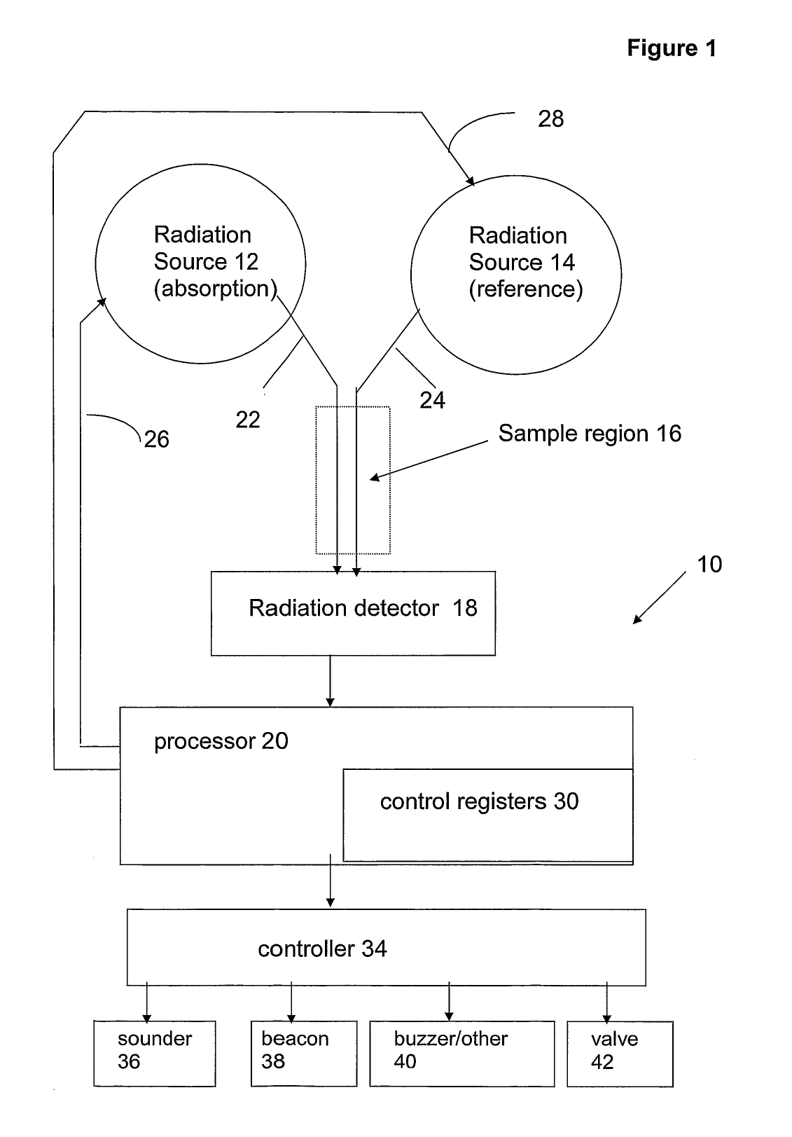

FIG. 1 is a schematic drawing of the functional components of a gas detector in accordance with the invention;

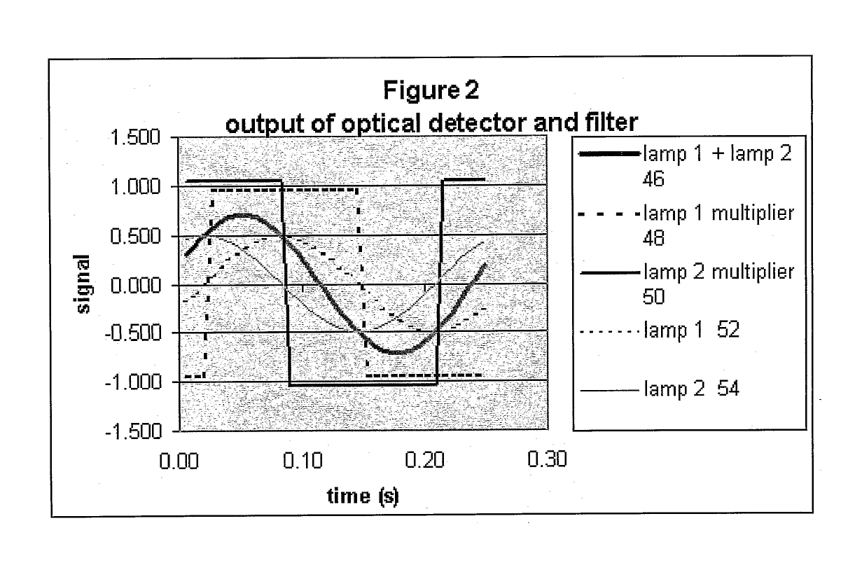

FIG. 2 is a example of a sample signal gathered by an optical sensor in a system representative of the invention;

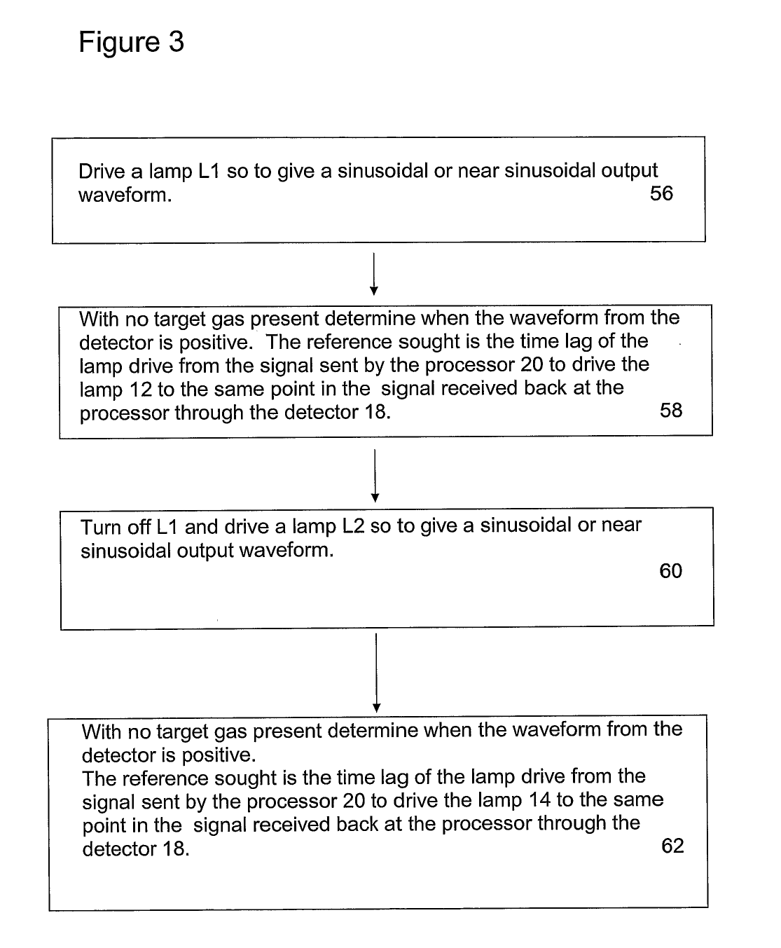

FIG. 3 is a schematic flow diagram of the steps involved in calibrating the relative phases of a system according to the invention in order to be able to determine the relative phases of lamps forming part of the system according to the invention; and

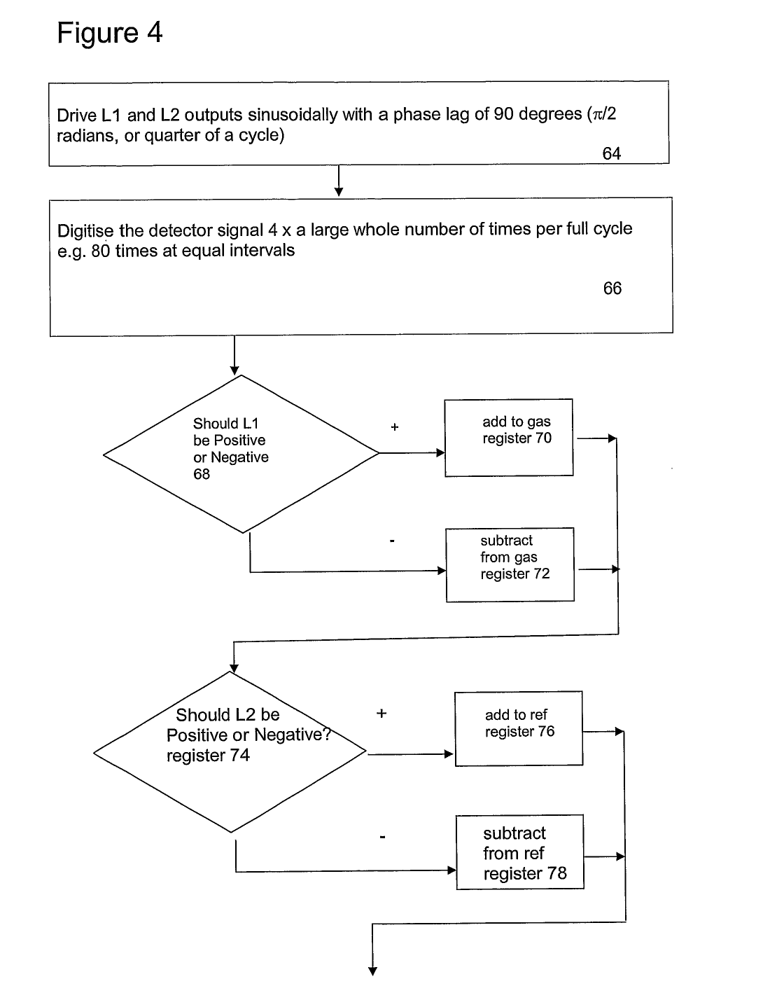

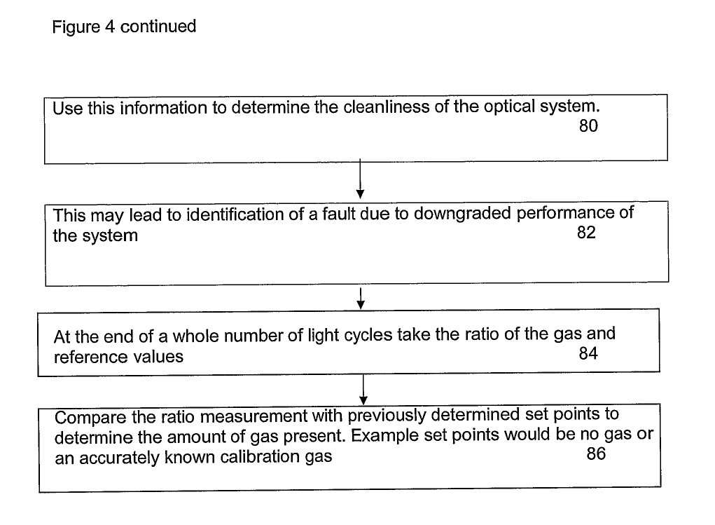

FIG. 4 is a block diagram of a representative system showing an example of the processing required to gain a measurement of gas.

Referring to FIG. 1 there is shown a gas detector 10 according to the invention comprising a first radiation source 12 and a second radiation source 14. The radiation sources might for example be lamps emitting radiation in the optical or infrared frequency bands. The gas detector further comprises a sample region 16, in which region the target gas to be detected is present in use, and a detector 18. Examples of the radiation sources and detector are for example an MGG1160-080-2.5MM lamp and an LIE302x034 detector. The gas detector 10 further comprises a processor 20 which might be in a form of a microprocessor such as a Renesas H8/3048. The first and second radiation sources 12, 14 are arranged to emit light along paths 22 and 24 respectively, through sample region 16 to detector 18.

The processor 20 is configured to drive the radiation sources 12 and 14 as indicated along communication channels 26 and 28, thereby to control the amplitude, frequency and/or phase of radiation emitted from the first and second radiation sources. Processor 20 preferably comprises a memory store such as control registers 30 enabling storage of data. Further, the processor 20 is preferably in communication with a controller 34 which is able to act on information from processor 20 in order to actuate various devices such as sounder 36, beacon 38, buzzer and/or other warning device 40, and a valve 42 such as a shut off valve in a fluid communication system, thereby to respond appropriately for example if a flammable gas detected. In some examples of the equipment the processor 20 is able to drive the warning devices 36, 38, 40 and 42 directly.

In one form of the invention, the first and second radiation sources 12 and 14 are driven by processor 20 to emit light at different frequencies, the first radiation source emitting light at a first frequency known to be absorbed by a predetermined, target gas which it is desired to be detected within the sample region 16 and the second radiation source 14 emitting radiation at a different frequency known not to be absorbed by the gas. In another form, the radiation sources are identical except that filters are provided between the radiation sources and a sample volume along the radiation paths 22 and 24. A filter can be provided as part of a lamp itself or as a separate item thereby to enable for example band pass selection of appropriate frequencies of radiation from the first and second radiation sources 12 and 14.

The radiation detected by detector 18 is converted into a signal which is passed to processor 20 as shown in FIG. 1. Processor 20 is able to store information from the signal from detector 18 in the memory store such as control registers 30 and to pass information to controller 34. Controller 34 might for example be a remote device in communication with the various safety elements such as sounder 36.

Referring to FIG. 2 there is shown a graph 44 representative of a signal detected by detector 18 against time. Graph 44 shows the signal 46 representative of radiation detected simultaneously from both the first and second radiation sources 12 and 14. In this example, an amplitude modulated signal 46 is detected by detector 18 being the combination of radiation at different frequencies from the first and second radiation sources. Preferably, from the calibration technique, described later, the amplitude of radiation from the first and second radiation sources 12, 14 is substantially similar in the absence of any of the target gas in the sample region 16. In this example, the radiation components from each of radiation source 12 and second radiation source 14 (lamp 1 and lamp 2 respectively in FIG. 2) are shown in lines 52 and 54 respectively. As can be seen, each of the component signals from the first and second radiation sources 12, 14 or sinusoidally varying signals having different phases. Preferably the frequency of the amplitude modulation is the same but a 90 degrees phase shift is applied to the first and second radiation sources by processor 20.

In order to determine the relative contributions of radiation from first radiation source and second radiation source in the single, simultaneously, detected signal 46 the processor 20 analyses the signal from detector 18 and stores values representative of the components of the signal 46 in two separate memory stores (or registers 30). A multiplier is applied to the component signal prior to storage in the separate registers. The multiplier is + or −1 depending on the phase of the components of the signals generated by the separate first and second radiation sources which make up the signal.

Accordingly, the processor 20 operates a digital filter algorithm in order to extract information from the only available net signal 46 from detector 18 as if in fact two separate optical detectors had been used.

Referring to FIG. 3, there is shown a flow diagram of the steps involved in calibrating a gas detector 10 in order to enable processor 20 to determine the relative phases of radiation detected at detector 18 from the first and second radiation sources 12 and 14 in accordance with the control signals from processor 20 which are sent along communication channels 26 and 28 to the radiation sources in order to drive the emission of radiation.

As indicated at step 56 in FIG. 3, initially, only the first radiation source 12 (or lamp L1) is driven in a near sinusoidal manner in order to generate a sinusoidal or near sinusoidal waveform. An example would be to drive the lamp at a very high frequency using a pulse width modulation technique. As indicated at step 58, the processor 20 is configured to determine, during this calibration phase with no target gas present in the sample region 16, when the waveform from detector 18 is positive with reference to a relative characteristic of the system, such as the time of the lamp drive signal from processor 20 as indicated at step 58. Accordingly, it is possible to capture a signal a number of times during the transmission of a waveform from the first radiation source (at L1, 12) using detector 18 and to process the signal from detector 18 using processor 20 to determine if the signal is above the average signal for the whole of a waveform. If the detected instantaneous signal is above the average level the processor determines that the emission from the radiations source detected at detector 18 is in a positive section of the cycle and conversely can detect when the signal is in a negative part of the waveform. The processor is then able to determine the start of the cycle and to determine the relative timing (or time lag) between a reference signal such as the signal to drive the first radiation source 12 from processor 20 and the detection of that start of the cycle at the detector 18. Accordingly, the phase of the radiation from the first radiation source 12 can be calibrated and this process can then be repeated for the second radiation source 14 (or lamp L2) by turning off lamp L1 and driving lamp L2 in the same manner as indicated at steps 60 and 62 in FIG. 3.

Accordingly, the processor 20 is able through this calibration process (which might be automated or manually conducted at manufacture, installation and/or periodically throughout the use of the gas detector 10) to establish the signal phase in order to enable the digital filtering process described above in relation to FIG. 2, in other words establish the timing of the relative multipliers 48 and 50 in relation to the signals 52 and 54 from the first and second radiation sources.

Having calibrated the gas detector 10 for the phase of radiation from the first and second radiation sources, as well as any other necessary calibration such as signal amplitude detected at detector 18 from the separate first and second radiation sources it is possible to operate the gas detector continuously to monitor for the presence of a predetermined (or target) gas in the sample region 16. A flow chart of the operational steps is shown in FIG. 4. At step 64, the processor 20 operates to drive first and second radiation sources 12, 14 (or lamps L1 and L2) with a sinusoidal varying waveform having a 90 degrees phase lag.

Detector 18 digitises the captured signal providing an output signal to processor 20 comprising at least four values per cycle (one value per quarter cycle) of the complete waveform of the net signal 46 detected at detector 18. Indeed, preferably a large whole number of multiples of four detected signals is determined by detector 18 such as 80 as indicated at step 66. Using a discrete digitised output from detector 18, 20 discrete signal values are provided for each quarter cycle and hence allow sufficient data collection and storage in the memory store or register 30 to enable appropriate analysis for gas detection. The processor 20 further acts to determine the multiplier which is supplied to the signal detected at detector 18 for storage in a first and second memory store or register 30. A first register is used to store information related to the absorption signal or radiation detected from the first radiation source. This might be called the gas register when the frequency of radiation from the first radiation source is an absorption frequency of the target gas to be detected in the sample region 16. The second register is the reference register when radiation from the second radiation source is of a frequency known not to be absorbed by the target gas and hence states the reference signal data. Accordingly, as indicated at step 68, processor 20 determines the phase of radiation from the first radiation source (L1, 12) and whether or not it should be positive or negative and applies the appropriate addition or subtraction multiplier (48 shown in FIG. 2) and hence either adds the signal to the gas register as shown in step 70 or subtracts the signal from the gas register as shown at step 72.

At step 74, this process is repeated in relation to the known phase of radiation from the second radiation source 14 or lamp L2. Accordingly, the multiplier 50 shown in FIG. 2 is applied to the net signal 46 and the value of the signal is either added to the reference register as indicated at step 76 when the phase of the signal 54 from the second radiation source 14 is positive, or subtracted from the data in reference register as indicated at step 78 when the phase of the radiation 54 from the lamp L2 (second radiation source 14) is negative.

The individual data storage events can be used to determine the cleanliness of the optical system as indicated at step 80. Preferably, this is achieved by comparison of the register of L2 with that same register when the gas detector was last calibrated for zero target gas presence, to determine any attenuation of the reference signal.

In the event of identification of a fault due to downgraded performance of the system, then the need for action can be taken such as a specific alarm enabling automatic recalibration sequences and/or setting down of the gas detector and/or other safety devices to enable repair as indicated at step 82.

After at least one whole cycle of detection events, the ratio of the gas and reference signals stored in the gas register and reference registers can be determined as indicated at step 84.

The net value over time of the registers will be the same in the circumstances of equal amplitudes of detected radiation from first and second radiation sources (or of a known ratio depending on the amplitudes of radiation from the first and second radiation sources 12, 14 and other factors in the gas detector as a whole). This characteristic will be the same in the absence of any target gas in the sample region 16. However, in the event of the presence of the target gas in the sample region 16, then radiation from the first radiation source is absorbed by the gas and hence the signal amplitude will decrease enabling determination of this discrepancy in the ratios of the relative values in the gas register and reference register by the processor 20. Hence, processor 20 is able at step 86 to determine the presence in the sample region 16 (or optical system) of the target gas. In order to optimise the determination of the level of target gas, carrier signals for lamp 1 and lamp 2 are preferably phase separated by 90 degrees and preferably the lamp multiplier (see FIG. 2) for each of lamps 1 and 2 is equally separated by a quarter cycle. However, different separations in both the carrier wave and the multipliers can be used.

Using lookup tables of the ratios of the absorption and reference signals and/or using other suitable methods such as an algorithm, processor 20 is able to determine the amount of the target gas in sample region 16 and is programmed to respond accordingly. For example, the ratios can be determined by using a calibrated amount of gas during a calibration sequence in order to provide a lookup table. Accordingly, depending upon the ratios of the signal information in the gas and reference registers, the processor 20 is able to determine the concentration of predetermined gas in sample region 16 and to act accordingly. In one example where methane is the target gas, the safety requirements might be that the flammable level of the gas is set by regulation at 4.4% by volume of the ambient atmosphere and that a warning of increasing levels of methane in the ambient atmosphere (as determined at sample region 16) will be given at 20% of this value (in other words at 0.88% by volume methane detected) and an alarm or other significant activation such as shut down of systems by closing valves as indicated at valve 42 in FIG. 1, might be effected for gas levels in the order of 40% the flammable level (in other words when 1.76% by volume methane is determined to be present in the sample region 16).

In the case of methane detection, the frequency of the absorption radiation from the first radiation source 12 is preferably centred around 3.3 microns and the reference frequency around 3.0 microns. In other forms, a wider band of frequencies are emitted from the first radiation source to cover more than one of the absorption figures of the gas such that in the case of methane, the radiation from the first radiation source might include both wavelengths of 3.4 and 2.3 microns, or in the case of carbon dioxide detection might include the wavelengths of 4.2 microns and 2.75 microns. Naturally, the radiation from the second (reference) source 14 should be outside the absorption regions of the target gas.

In a different form, the radiation from the first and second radiation sources 12, 14 are not amplitude modulated but frequency modulated such that the absorption and reference signals are derived by transformation of two overlapping signals e.g. by Fourier transform into the frequency domain. For example a fundamental 35 hertz carrier signal might be modulated by a 5 and 7 hertz modulation frequency for the first and second radiation sources respectively. Accordingly, a Fourier transformation of the signal detected at detector 18 by processor 20 would enable storage of information using a digital filtering technique into separate registers in order to determine the relative values of signals detected from the first and second radiation sources respectively, in a manner similar to that for the amplitude modulation technique described above.

1. A gas detector comprising a first radiation source for emitting radiation at a first frequency, a second radiation source for emitting radiation at a second frequency, a radiation detector adapted simultaneously to detect radiation from both the first and second radiation sources which in use pass through a sample region located between the first and second radiation sources and the detector, further comprising a processor enabling comparison of the radiation detected by the detector from the first and second radiation sources thereby to determine the level of a target gas in the sample region, characterised by the first and second frequency having a phase separation and the processor being adapted to store a first segment of each cycle of the detected radiation signal to a first memory store and a second, temporally different segment of each cycle of the detected radiation signal to a second memory store.

2. A gas detector according to claim 1 wherein part of the first segment is added to and part of the first segment is subtracted from the content of the first memory store, and similarly, part of the second segment is added to and part of the second segment is substantive from the content of the second memory store.

3. A gas detector according to claim 1, the first segment is approximately a full cycle of detected radiation and the first and second parts of the first segment are each approximately half of a full cycle of the detected radiation, and/or the second segment is approximately a full cycle of the detected radiation and the first and second part of the second segment are each approximately half a cycle of the detected radiation signal.

4. A gas detector according to claim 1, wherein the processor drives the first and second radiation sources to effect emission of the radiation, and/or wherein the first and second radiation sources are driven to emit radiation in a sinusoidal waveform.

5. A gas detector according to claim 3 wherein the radiation sources are driven using a pulse width modulation technique.

6. A gas detector according to claim 1, wherein the phase difference between the radiation from the first and second radiation sources is substantially 90 degrees.

7. A gas detector according to claim 1, wherein the processor is adapted to analyse an amplitude modulated signal from the detector representative of the radiation detected simultaneously for both the first and second radiation sources by the detector.

8. A gas detector according to claim 1, wherein the processor is adapted to analyse a frequency modulated signal from the detector representative of the radiation detected simultaneously for both the first and second radiation sources by the detector.

9. A gas detector according to claim 1 adapted to enable the processor to determine the relative phase of radiation detected by the detector from both the first and second radiation sources, and to analyse the signal from the detector representative of the simultaneously detected radiation from both the first and second radiation sources thereby to determine relative absorption of the radiation from one of the first and second radiation sources compared to the other of the first and second radiation sources.

10. A gas detector according to claim 9 comprising a first and second data store, wherein the processor is adapted to drive the first and second radiation sources with a 90 degree phase shift in the radiation emitted therefrom, and to determine the phase of radiation detected by the detector from both the first and second radiation sources such that the output signal from the detector, representative of the combined radiation detected from both the first and second radiation sources, is added to the first store for the first 180 degree of a cycle for radiation from the first radiation source and subtracted from the first store for the second 180 degrees of a cycle of radiation emitted from the first radiation source, and similarly the output signal from the detector is added to the second store for the first 180 degrees of a cycle of radiation emitted from the second radiation source and subtracted from the second store for the second 180 degrees of a cycle of the radiation emitted from the second radiation source, thereby to enable determination of the relative signals detected simultaneously by the detector from both the first and second radiation sources.

11. A gas detector according to claim 10 wherein the phase difference between the storing of the signal in the first and second stores and the phase difference created when driving the radiation emitted by the first and second radiation sources is the same and preferably approximately 90 degrees.

12. A gas detector according to claim 1, wherein the signal from detector is digitised and the processor is adapted to store the signal in one or more registers.

13. A gas detector according to claim 1, wherein the radiation emitted by the first and/or second radiation source has a sufficient band width to cover two or more absorption wavelengths of the predetermined gas to be detected in the sample region.

14. A gas detector according to claim 1, wherein the detector is adapted to detect a second pair of radiation signals from the first and second radiation sources which second pair of signals are superimposed on the first radiation signals from the first and second radiation sources and preferably the second radiation frequency is a whole number multiple of the frequency of the first pair of radiation signals beneficially enabling determination of the concentration of a second type of gas.

15. A method of detecting a target gas comprising emitting radiation at a first frequency from a first radiation source through a sample region to a detector, and emitting radiation at a second frequency from a second radiation source through the sample region to the detector, detecting the radiation from both the first and second radiation sources simultaneously at the detector and analysing the signal from the detector representative of the simultaneously detected radiation from both the first and second radiation sources to determine the level of a target gas in the sample region.

16. A method according to claim 15 comprising using a processor to drive the first and second radiation sources to effect emission of the radiation.

17. A method according to claim 15 wherein first and second radiation sources are driven to emit radiation in a sinusoidal wave form.

18. A method according to claim 17 wherein the radiation sources are driven using a pulse width modulation technique.

19. A method according to claim 15, wherein the first and second radiation sources are driven to emit radiation having different temporal characteristics such as different phase, and preferably wherein the phase difference between the radiation from the first and second radiation sources is substantially 90 degrees.

20. A method according to claim 15, further comprising analysing an amplitude modulated signal from a detector representative of the radiation detected simultaneously for both the first and second radiation sources by the detector.

21. A method according to claim 15, further comprising determining the relative phase of radiation detected by the detector from both the first and second radiation sources, and to analyse the signal from the detector representative of the simultaneously detected radiation from both the first and second radiation sources thereby to determine relative absorption of the radiation from one of the first and second radiation sources compared to the other of the first and second radiation sources.

22. A method according to claim 21 comprising the steps of driving the first and second radiation sources with a 90 degree phase shift in the radiation emitted therefrom, and determining the phase of radiation detected by the detector from both the first and second radiation sources such that the output signal from the detector, representative of the combined radiation detected from both the first and second radiation sources, is added to a first store for the first 180 degree of a cycle for radiation from the first radiation source and subtracted from the first store for the second 180 degrees of a cycle of radiation emitted from the first radiation source, and similarly the output signal from the detector is added to a second store for the first 180 degrees of a cycle of radiation emitted from the second radiation source and subtracted from the second store for the second 180 degrees of a cycle of the radiation emitted from the second radiation source, thereby to enable determination of the relative signals detected simultaneously by the detector from both the first and second radiation sources.

23. A method according to claim 22 wherein the phase shift between the storing of the signal in the first and second stores is equal to the phase shift created when driving the radiation emitted by the first and second radiation sources, and is preferably approximately 90 degrees.

24. A method according to claim 15, wherein the signal from the detector is digitised and stored in one or more registers.

25. A method according to claim 15, wherein the radiation emitted by the first and/or second radiation source has a sufficient bandwidth in which to cover two or more absorption wavelengths of the target gas to be detected in the sample region.

26. A method according to claim 15, further comprising detecting a second pair of radiation signals superimposed on the first radiation signals from the first and second radiation sources and preferably the second radiation frequency is a whole number multiple of the frequency of the first pair of radiation signals preferably thereby enabling determination of the concentration of a second type of gas, and/or enabling more accurate determination of the concentration of the target gas measured by the first pair of signals.

27. A method according to claim 15, further comprising analysing a frequency modulated signal from the detector representative of the radiation detected simultaneously for both the first and second radiation sources by the detector.

28. A method of calibrating a gas detector having a first radiation source for emitting radiation at a first frequency, a second radiation source for emitting radiation at a second frequency, and a radiation detector adapted simultaneously to detect radiation from both the first and second radiation sources, the method comprising the steps of driving one of the radiation sources and analysing the output signal from the detector to determine any inherent time lag in the system between driving the radiation source and detecting a signal in the detector.

29. A method according to claim 28 wherein the output signal from a processor to drive a radiation source is compared with the output signal from the detector to determine the inherent time lag.

30. A method according to claim 28 comprising calibrating the phase of both the first and second radiation sources separately thereby to enable determination of the component of the output signal from the detector which represents the positive and negative parts of the cycle for the radiation from each of the first and second radiation sources, and preferably thereby enables application of a digital filter to the net signal in use in order to enable determination of the strength of signal for each of the components of net signal representative of the first and second radiation sources.

31. A signal comprising radiation of a first frequency from a first source and radiation of a second frequency from a second source wherein the radiation from the first and second sources have identifiable temporal characteristics (such as a 90 degrees phase difference) and the ratio of the amplitudes of the radiation from the first and second radiation sources enables determination of the presence of a target gas.
